(19) United States
(12) Patent Application Publication
(10) Pub. No.: US 2022/0147076 A1
(43) Pub. Date: May 12, 2022

(54) SHABBAT COMPRESSOR

(71) Applicant: Yehuda Yuval Nagar, Jerusalem (IL)

(72) Inventor: Yehuda Yuval Nagar, Jerusalem (IL)

(21) Appl. No.: 17/509,007

(22) Filed: Oct. 24, 2021

Related U.S. Application Data
(60) Provisional application No. 63/110,993, filed on Nov. 7, 2020.

(51) Int. Cl. G05D 16/20; F17C 13/04; F17C 7/00; F17C 13/02

(52) U.S. Cl. CPC G05D 16/208; F17C 13/04; F17C 7/00; F17C 2227/0157; F17C 2205/0326; F17C 2250/03; F17C 2250/043; F17C 13/025

(57) ABSTRACT

A gas insulating interface between a compressed gas source and sink is presented. In some embodiments, the interface includes a primary tank for receiving a gas from the compressed gas source, a secondary gas tank for receiving a gas from the primary gas tank and for providing gas to the sink, valves for communicating the above elements, and/or a controller. The controller may control valves by control operations. Optionally, no control operation thereof responds to gas consuming immediately before the control operation. The controller may follow a predetermined duty cycle. The gas interface may include a pressure gauge of the primary gas tank and/or an emptying valve, which may communicate with the controller. Optionally, the gas insulating interface includes a detachable connector to the compressed gas source and/or a detachable connector to compressed devices. Optionally, there is a communication channel to the compressed gas source.

### RELATED APPLICATION/S

This application claims the benefit of priority under 35 USC § 119(e) of U.S. Provisional Patent Application No. 63/110,993 filed Nov. 11, 2020, the contents of which are incorporated herein by reference in their entirety.

### FIELD AND BACKGROUND OF THE INVENTION

The present invention, in some embodiments thereof, relates to a method and apparatus for supplying compressed air, and more particularly, but not exclusively, to a method and apparatus for supplying compressed air without direct human intervention, especially a human intervention by consuming compressed air.

Many prior art systems for providing compressed air to pneumatic devices send compressed gas from an air compressor, through a central air storage tank and/or an air supply network which might be dispersed over a facility like a hospital and/or a detachable pressure sink (e.g., a tire).

The consumption of compressed air by the compressed air devices may immediately trigger several electric operations, like opening pressure switches and turning on of an air compressor.

This mode of operation may not be suitable for use in Sabbath by people observing the Jewish religious laws, that prohibit a person from causing electrical machines to either turn on or turn off during the Sabbath. Some embodiments of the present invention supply compressed air to devices in a way that does not violate the Jewish religious laws, for example, by avoiding any activation of an electric device as a direct result of drawing compressed air.

### SUMMARY OF THE INVENTION

According to an aspect of some embodiments of the invention, there is provided a gas insulating interface for interfacing a compressed gas source with one or more compressed gas devices, the gas insulating interface including: a primary gas tank for receiving a compressed gas from the compressed gas source; a secondary gas tank for receiving a compressed gas from the primary gas tank and for providing a compressed gas to the one or more compressed gas devices; a primary valve for controlling gas communication between the compressed gas source and the primary gas tank; a secondary valve for controlling gas communication between the primary gas tank and the secondary gas tank; and a controller configured to control of the primary valve and the secondary valve by a plurality of automatic control operations, no control operation thereof responding to gas consuming immediately before the control operation by the one or more compressed gas devices.

According to some embodiments of the invention, the gas insulating interface further includes a pressure gauge for measuring gas pressure in the primary gas tank and communicating gas measurements to the controller.

According to some embodiments of the invention, the controller is configured to follow a predetermined duty cycle operation.

According to some embodiments of the invention, each cycle of the predetermined duty cycle operation includes a first period of closed secondary valve and open primary valve, and a second period of closed primary valve and open secondary valve.

According to some embodiments of the invention, the gas insulating interface further includes an emptying valve to enable controlled flow of gas out of the primary gas tank, and wherein an opening of the emptying valve is synchronized with the duty cycle.

According to some embodiments of the invention, the compressed gas source is one of a certain compressor and a central compressed gas tank, the central compressed gas tank configured for initiating an attached central compressor upon reduction of gas pressure below a certain threshold.

According to some embodiments of the invention, the certain compressor is programmed to start compressing in a predetermined duty cycle.

According to some embodiments of the invention, at least one of the one or more compressed gas devices is chosen from a group of devices consisting of a lifting device, a raising and lowering mechanism of a bed, a pneumatic wheelchair, a mobility scooter, an elevator, a solenoid control device, a manual air valve, and an air jet.

According to some embodiments of the invention, the controller is chosen from a group of devices consisting of a computer, an industrial controller, and a programmable computing device.

According to some embodiments of the invention, the controller includes a user interface for allowing programming of a duty cycle operation of the gas insulating interface.

According to some embodiments of the invention, the gas insulating interface further includes at least one of a detachable connector to the compressed gas source and a detachable connector to at least one of the one or more compressed gas devices.

According to some embodiments of the invention, the gas insulating interface further includes a communication channel to the compressed gas source for at least one of receiving a status thereof and preprogramming a duty cycle of an operation of the compressed gas source.

According to an aspect of some embodiments of the invention, there is provided a method for providing compressed gas using a gas insulating interface including a primary gas tank connectable to a compressed gas source and a secondary gas tank connectable to one or more compressed gas devices, the method including: controlling a primary valve switching gas communication between the compressed gas source and the primary gas tank; controlling a secondary valve switching gas communication between the primary gas tank and the secondary gas tank; and wherein no operation selected from the controlling the primary valve and controlling the secondary valve is in response to gas consuming by any of the one or more gas compressed devices immediately before the operation.

According to some embodiments of the invention, the method of further includes a synchronizing the switching gas communication between the primary gas tank and the secondary gas tank and the switching gas communication between the primary gas tank and the secondary gas tank to a predetermined duty cycle of the compressed gas source.

According to some embodiments of the invention, the method of further includes a step of receiving a gas pressure measurement associated with the primary gas tank.

According to some embodiments of the invention, the method of further includes a step of synchronizing an emptying valve associated with predetermined duty cycle.

According to some embodiments of the invention, the method of further includes at least one step of a step of attaching the gas insulating interface to the compressed gas source and a step of attaching at least one of the one or more compressed gas devices to the gas insulating interface.

According to some embodiments of the invention, the method of further includes at least one step of a step of programming a duty cycle of the compressed gas source and a step of programming a duty cycle of the gas insulating interface.

According to an aspect of some embodiments of the invention, there is provided a gas system including: a compressed gas source; one or more compressed gas devices connected to the compressed gas source by a gas insulating interface including: a primary gas tank for receiving compressed gas from the compressed gas source; a secondary gas tank for receiving compressed gas from the primary gas tank and for providing a compressed gas to the one or more compressed gas devices; a primary valve for controlling gas communication between the compressed gas source and the primary gas tank; a secondary valve for controlling gas communication between the primary gas tank and the secondary gas tank; and a controller configured for automatic control of the primary valve and the secondary valve by a plurality of control operations, no control operation thereof responding to gas consuming immediately before the control operation by the one or more compressed gas devices.

According to some embodiments of the invention, the controller following a predetermined duty cycle operation.

According to an aspect of some embodiments of the invention, there is provided an interface between a compressor activated according to a duty cycle and pressure sink including: a controller synchronized to the duty cycle; and a pneumatic valve positioned on a flow path between the compressor and the pressure sink, the pneumatic valve synchronized by the controller to the duty cycle of the compressor.

According to some embodiments of the invention, the controller is configured to close the pneumatic valve during an actor portion of the duty cycle.

According to some embodiments of the invention, the interface further includes a pressure storage tank positioned on a flow path between the compressor and the pneumatic valve and a pressure sensor responsive to a pressure in the pressure storage tank and wherein the compressor is responsive to the pressure sensor to stop compressing when a pressure in the pressure storage tank is greater than a threshold.

According to some embodiments of the invention, the interface further includes a pressure release configured to release pressure from the pressure storage tank prior to opening the pneumatic valve.

According to an aspect of some embodiments of the invention, there is provided a method of supplying pressure from a compressor to a pressure sink including: activate the compressor according to a duty cycle having an active period and an inactive period; block a flow path between the compressor and the pressure sink during the active period; and allow flow along the flow path during the inactive period only.

According to some embodiments of the invention, the method further includes: collect pressurized gas in a storage tank during the active period and wherein the flow path is between the storage tank and the pressure sink.

According to some embodiments of the invention, the method further includes shut of the compressor during the active period when a pressure in the storage tank is greater than a threshold.

According to some embodiments of the invention, the method further includes releasing pressure from the storage tank before a beginning of the active period.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic system for providing compressed gas to pneumatic devices according to the prior art;

FIG. 2A is a schematic drawing of a system for providing compressed gas to pneumatic devices in according to some embodiments of the invention;

FIG. 2B is a schematic drawing of a gas insulating interface according to some embodiments of the invention;

FIG. 3 depicts an exemplary time duty cycle operation of a system for providing compressed gas to pneumatic devices according to some embodiments of the invention;

FIG. 4 is a flowchart of the controller of a gas insulating interface according to some embodiments of the invention

FIG. 5 is a flowchart of the operation of the gas insulating interface according to some embodiments of the invention;

FIG. 6 is a block diagram of an apparatus for producing compressed air in accordance with an embodiment of the current invention;

FIG. 7 is a flow chart diagram of method for producing compressed air, including optional features, in accordance with an embodiment of the current invention;

FIG. 8 is a schematic drawing of an apparatus for producing compressed air in accordance with an embodiment of the current invention; and

FIG. 9 is a block diagram of a compressed air system in accordance with an embodiment of the current invention.

### DESCRIPTION OF SPECIFIC EMBODIMENTS OF THE INVENTION

The present invention, in some embodiments thereof, relates to a method and apparatus for supplying compressed air, and more particularly, but not exclusively, to a method and apparatus for supplying compressed air without direct human intervention, especially a human intervention by consuming compressed air.

In some embodiments thereof, a method and apparatus produce compressed air, and/or automatically produces compressed air without direct human intervention.

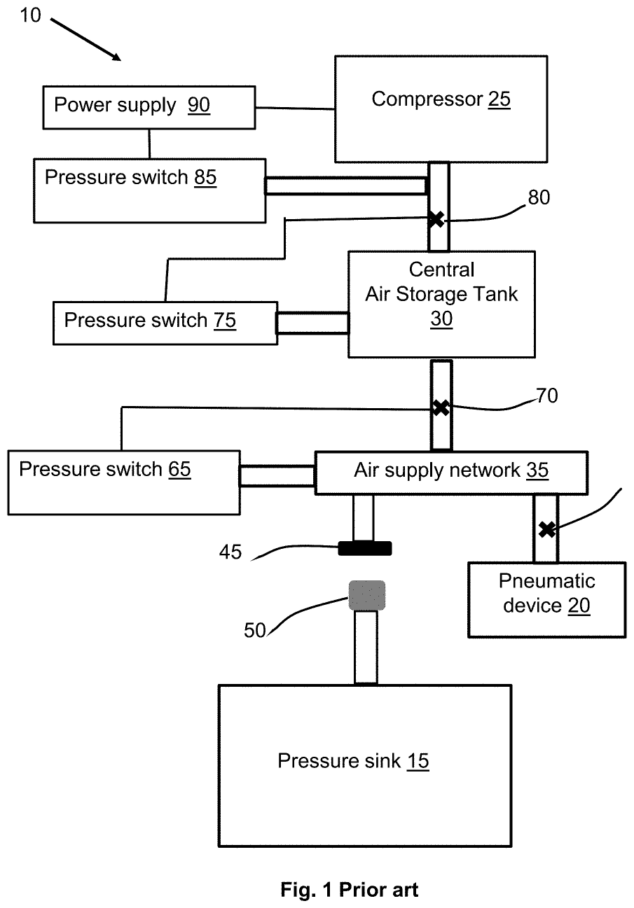

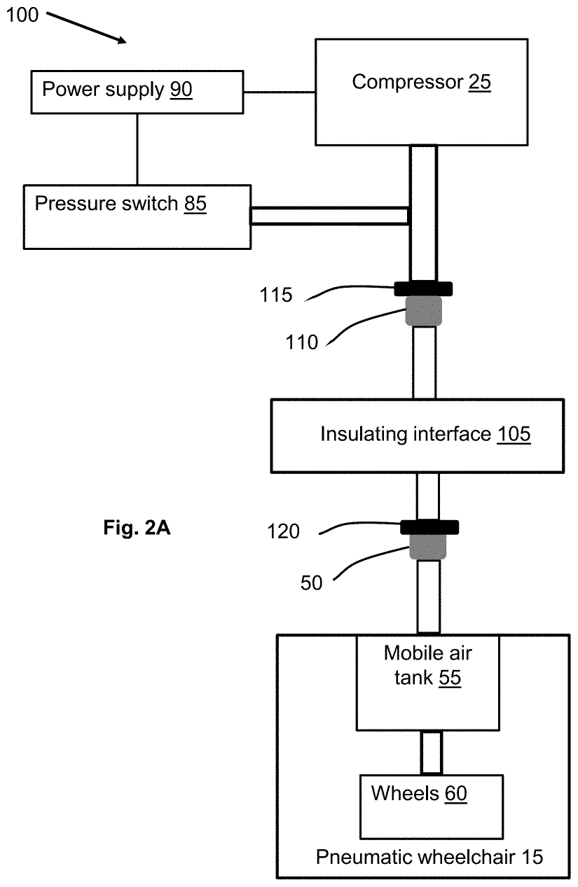

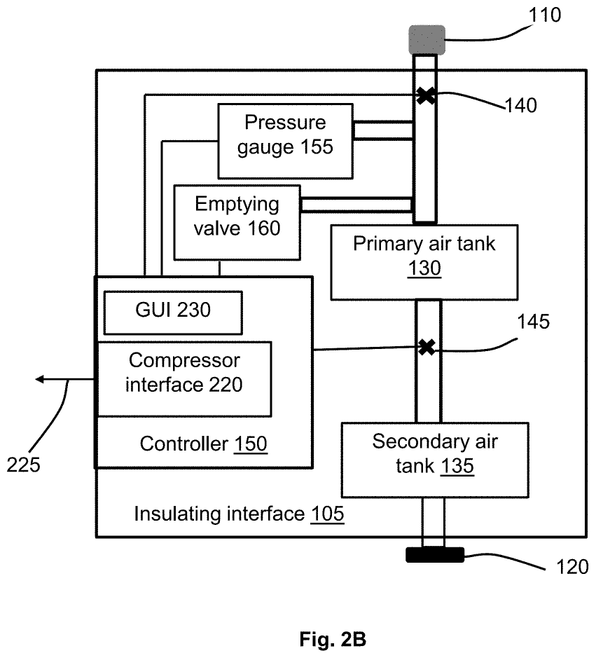

For purposes of better understanding some embodiments of the present invention, as illustrated in FIGS. 2 to 9 of the drawings, reference is first made to the construction and operation of a compressor system as illustrated in FIG. 1.

In the prior art, described for an example only by FIG. 1, a system 10 for providing a compressed air to pneumatic sinks 15 and 20 gets compressed gas from a source, air compressor 25, for example. The compressor 25 feeds a central air storage tank 30, connected to an air supply network 35, which might be dispersed over a facility like a hospital.

Certain devices, for example sink 20, are connected fixedly to air supply network 35 and use a human operated valve, valve 40 for example, to draw air from the air supply network 35. In contrast, detachable pressure sink 15 for example a tire, may be connected to the air supply network 35 using detachable connecting terminals 45 and 50, a female and a male connecting plugs respectively, for example.

Once the pressure sink 15 connects to the air supply network, its mobile air tank 55 is fed by compressed air from the air supply network 35. Once a pressure gauge (not shown) connected to a mobile gas tank 55 shows that a sufficient gas pressure has been accumulated, the user disconnects the sink 15 from the air supply network 35 and is free to move around.

The consumption of compressed air by the sinks 15 and 20 may initiate several electric operations. A pressure switch 65 connected to air supply network 35 may immediately sense a decrease of gas pressure thereof below a predetermined low air pressure. Consequently, the pressure switch 65 switches a closed valve 70 to an open state, and the air supply network 35 gets compressed air from the central air storage tank 30 until its air pressure rises above a predetermined high air pressure.

Similarly, a pressure switch 75, connected to the central air storage tank 30, senses the gas pressure thereof, and if it is too low it opens a valve 80 to the compressor 25. Consequently, a pressure switch 85 senses an air pressure below a predetermined threshold and triggers power supply 90 to initiate operation of compressor 25.

This mode of operation is not suitable for use in Sabbath by people observing the Jewish religious laws, that prohibit a person from causing electrical machines to either turn on or turn off during the Sabbath. Some embodiments of the present invention may be used to supply compressed air in a way that does not violate the Jewish religious laws.

### Overview

An aspect of some embodiments of the current invention relates to a powered apparatus for producing compressed air. Optionally, the apparatus comprises at least one of a controlling device, an air compressor, a compressed air storage tank, a compressed air supply tank, pneumatic valves, pneumatic pressure switches, pneumatic pressure gauges, pneumatic air hoses, pneumatic coupling apparatus, and/or any other pneumatic components commonly used in the production and/or delivery of compressed air.

In an aspect of some embodiments of the present invention, the current invention may be used to supply compressed air to machines that are powered by compressed air, wherein the supply is not dependent on any direct action by a human. In an aspect of some embodiments, the present invention may be used to supply compressed air in a way that does not violate Jewish religious laws that prohibit a person from causing electrical machines to either turn on or turn off during the Sabbath, for example the motor of an air compressor. For example, in existing pneumatic systems, a person drawing compressed air from the supply tank to power a pneumatic device may cause a compressor to be activated as a direct result of the air pressure in the supply tank dropping below a threshold.

The present invention, in some embodiments, comprises a method and apparatus for providing a supply of compressed air without directly responding to a human causing a drawing of compressed air from a supply tank. For example, the present invention may only allow the compressor to operate during an on period of a duty cycle, and then only when there is no draw of compressed air from the apparatus. In this manner, the Jewish prohibition of a person directly causing a compressor to operate during the Sabbath is not violated, since the apparatus automatically re-supplies compressed air during the on periods of a duty cycle, without responding directly to the lowering of air pressure resulting from a person drawing compressed air.

It is disclosed a gas insulating interface for interfacing a compressed gas source with compressed gas devices. In some embodiments, the gas insulating interface includes a primary gas tank for receiving a compressed gas from the compressed gas source, and a secondary gas tank for receiving a compressed gas from the primary gas tank. In some embodiments, compressed air is provided from the secondary gas tank to the compressed gas devices. The gas interface optionally includes a primary valve for controlling gas communication between the compressed gas source and the primary gas tank, a secondary valve for controlling gas communication between the primary gas tank and the secondary gas tank, and/or a controller. For example, the controller controls automatically the primary and secondary valves by a plurality of control operations. Alternatively or additionally, an interface may include a single tank and/or valves that control connections to the pressure source and/or a pressure sink. Optionally, the control operations are independent of and/or are not in response to gas consuming by the any of the compressed gas devices immediately before the control operation.

In an aspect of some embodiments of the present invention, the controlling device delivers power to the compressor with a periodic duty cycle of alternating periods of supplying power and not supplying power. When operating, the compressor supplies compressed air to the storage tank. Optionally, the supply of power to the compressor is additionally controlled by a pressure switch connected to the storage tank. Optionally when the air pressure in the storage tank reaches a threshold pressure, the pressure switch causes stopping the supply of power to the compressor. Optionally while the controlling device is supplying power to the compressor during the on period of the duty cycle and/or detects that the compressor has stopped operation, the controlling device ceases to supply power to the pressure switch and/or the compressor until the beginning of the next on period of the duty cycle.

Optionally, the compressor supplies compressed air to a storage tank. Optionally, the storage tank is connected to a supply tank, whereby compressed air from the storage tank may flow into the supply tank. Optionally the connection between the storage tank and/or the supply tank is controlled the control device by means of a pneumatic valve. When the control device causes the pneumatic valve to open, compressed air may flow from the storage tank to the supply tank.

In an aspect of some embodiments of the present invention, the control device only opens the pneumatic valve for a defined time period, and only when the compressor is not operating. The defined period of time may be less than the time required to reach the next on period of the duty cycle. For example, in some embodiments of the current invention, reduced pressure in the storage tank which was caused by opening the pneumatic valve would not cause the compressor to begin operating immediately, rather the compressor would only begin operating at the beginning of the next on period of the duty cycle, without reference to the air pressure in the storage tank.

In an aspect of some embodiments of the present invention, the control device is connected to an electrical power supply, for example an AC electrical outlet and/or a DC electrical storage battery, as is known in the art. The electrical power supply may be connected directly to other components of the invention, for example the pneumatic valve, the pressure switch, the compressor, the pressure regulator, and/or or any other components of the present invention that require electrical power to operate. Optionally, when the power supply is connected directly to other components, the control device may control the operation of the components, for example opening and/or closing the pneumatic valve, turning on or off the operation of the compressor, and the like. Alternatively or additionally, the power supply may be connected directly to the control device, and the control device may supply power to the other components.

In an aspect of some embodiments of the present invention, the compressed air in the supply tank may be connected to and/or provide power to pneumatic devices, for example a lifting device to raise patients in a hospital, a lifting device to raise any object, raising and lowering sections of a hospital bed, powering a wheel chair, powering a mobility scooter, powering an elevator, and/or any other type of pneumatic powered mechanism.

In some embodiments of the present invention, an insulating interface may be supplied between an existing compressed air source (for example as illustrated in FIG. 1) to supply compressed gas in accordance with Jewish religious law on Shabbat and/or holidays. Alternatively or additionally, compressed air source (for example as illustrated in FIG. 1) to supply compressed gas in accordance with Jewish religious law on Shabbat and/or holidays.

The gas of the present disclosure may be atmospheric air, dry air, nitrogen, carbon dioxide, or any other gas consumed by a compressed gas device in a facility or domestically. For the sake of convenience, air which is the most common gas used in medical and industrial environments is used in the following description.

### EXEMPLARY EMBODIMENTS

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Unless otherwise defined, all technical and scientific terms used herein have the same meaning as commonly understood by one of ordinary skill in the art to which this invention belongs. The systems, methods, and examples provided herein are illustrative only and not intended to be limiting.

The steps of the described methods may be executed in other order, repeated or skipped.

### A Gas Insulating Interface Embodiment (FIGS. 2A, 2B, 3, 4)

An exemplary system 100 for providing compressed gas to gas sinks 15 and 20 according to some embodiments of the invention is depicted schematically in FIGS. 2A and 2B. The system 100 includes a gas insulating interface 105 for interfacing a compressed gas source, a compressor 25 in the example of FIG. 2A, with compressed gas sinks 15, for example a pneumatic wheelchair.

The compressor 25 may be programmed to start compressing in a predetermined duty cycle without dependence on outlet gas pressure.

In some embodiments, the compressed gas source is central compressed gas tank 30, which initiates a compressor 25 upon reduction of gas pressure thereof below a certain threshold.

In the example of FIG. 2A, the gas insulating interface 105 includes a detachable connector 110 for connection to a detachable connector 115 of the compressor 25, and/or a detachable connector 120 for connection to a detachable connector 50 of the sink 15. Connectors 50 and 110 may be male connectors while connectors 115 and 120 are detachable female connectors, for example only.

In some embodiments, before Sabbath commences, e.g., late Friday afternoon, the insulating interface is connected to the compressor 25 by mating detachable connectors 110 and 115. During Sabbath, that ends in early Saturday evening, an observing person that needs a compressed air operation, connects the compressed air device (e.g., sink 15 or 20) by mating detachable connectors 50 and 120, and consumes air without any immediate initiation of an electrical device, as further detailed below.

Alternatively or additionally, the gas insulating interface 105 is fixedly connected to a compressed gas source (e.g., compressor 25 or tank 30) or to a fixed compressed gas device (e.g., sink 20).

The insulating interface 105 of FIG. 2B includes a primary air tank 130 for receiving a compressed air from the compressed air source (e.g., compressor 25), and a secondary air tank 135 for receiving a compressed air from the primary air tank 130 and for providing it to any compressed air sink 15, 20 for example. The insulating interface 105 further includes a primary valve 140 for controlling air communication between the compressed air source (e.g., compressor 25) and the primary air tank 130, a secondary valve 145 for controlling gas communication between the primary air tank 130 and the secondary air tank, and/or a controller 150. Optionally, the controller 150 controls automatically the primary valve 140 and/or the secondary valve 145 in a plurality of control operations, like reading status, opening and closing.

An optional pressure gauge 155 may measure gas pressure in the primary tank 130 and communicates gas measurements to the controller 150.

An optional emptying valve 160, controlled by the controller 150 and connected to the primary tank 130, allows a controlled flow of air out of the primary tank 130.

In some embodiments, the compressed gas devices are any of a lifting device (e.g., a fixed elevator may be connected to the pressurized gas source e.g., sink 20), a raising and lowering mechanism of a bed, a pneumatic wheelchair (e.g., a pneumatic wheelchair may be reversibly connected to the pressurized gas source e.g., sink 15), a mobility scooter, an elevator, a solenoid control device, manual air valve, air jet, etc.

In some embodiments, the controller 150 includes a computer, an industrial controller, and/or a programmable computing device.

In some embodiments, no control operation of controller 150 responds to air consuming immediately before the control operation by any of the compressed gas sinks 15 or 20. Thus, the prohibition of the Jewish religious laws on causing electrical machines to either turn on or turn off during the Sabbath is fulfilled by using the insulating interface 105 during Sabbath. Any operational method that provides that insulating operational mode of the insulating interface 105 is included in the frame of the current invention.

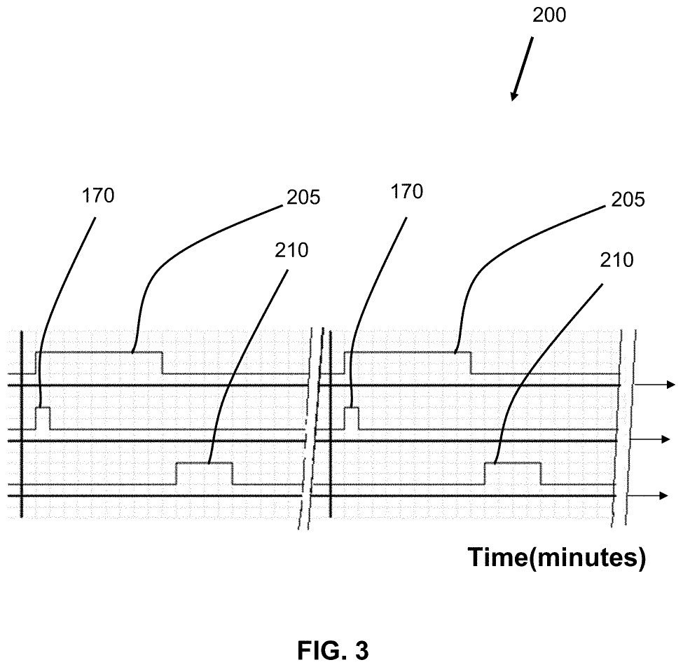

An exemplary method to achieve that insulating operational mode is to let the controller 150 follow a predetermined duty cycle operation, as illustrated in an exemplary time duty cycle 200 of FIG. 3, in which two subsequent cycles are shown. Each cycle includes a first period 205 of a closed secondary valve 145 and an open primary valve 140, and a second period 210 of a closed primary valve 140 and open secondary valve 145. Thus, without any dependence on a recent operation of any user of the compressed air sinks 15 or 20, the compressed gas source (e.g., compressor 25) may provide compressed air to the primary air tank 130 in the first period 205. In the second period 210, the secondary electric valve 145 is kept open for the whole period 210 and the primary tank 130 is free to provide compressed air to the secondary air tank 135 in accordance with the pressure edge of tank 130 over tank 135.

In some embodiments, for example when the compressed gas source is a central air tank 30, it may provide compressed air by having much higher pressure that the primary air tank 130 and may later initiate compressed air supply from a compressor 25.

In some embodiments, for example, when the compressed gas source is a compressor 25, the compressor 25 may be preprogrammed to start operation once the first period 205 begins if the primary air tank 130 has less pressure than a certain threshold. For that sake, controller 150 may have a compressor interface 220 connected to a communication channel 225 to the compressor 25 for receiving a status thereof and for preprogramming a duty cycle of an operation of the compressor 25 in accordance with the duty cycle of the interface 105. The communication channel 225 may be a wired or a wireless channel.

Optionally, pressure gauge 155 and emptying valve 160 are used to initiate operation of the compressor 25 as follows. The compressor 25 is configured to start working if the pressure at its outlet, as result of connection to the primary tank 130, is lower that a first threshold pressure, and continues to work until the pressure rises to a second threshold pressure. If the pressure measured by the pressure gauge 155 is above the first threshold, the controller 150 opens the emptying valve 160, such that during a period 170, the pressure drops below the first threshold and the compressor 25 starts working. Alternatively or additionally, the emptying valve 160 may be opened automatically before the 135 in primary tank is connected to the compressor 25 and/or central air storage tank 30.

Alternatively, the emptying valve may be activated automatically each cycle or each other cycle, for example. Another option is that the controller 150 receives status of the compressor 25 through communication channel 225 and activates the emptying valve in case that the compressor has not been working for 5 seconds, for example, after the first period 205 have started. In some embodiments, the interface may include only one tank (e.g., the primary tank 130 without secondary tank 135).

In some embodiments, (e.g., the primary tank 130 without secondary tank 135) before filling tank 130, valve 145 may be closed and/or emptying valve 160 may be opened to empty tank 130 and/or central air storage 30 of the compressor. Optionally, the emptying valve 160 is closed while valve 140 is opened and/or the compressor 25 runs for a fixed time and/or until tank 30 and/or 130 reach a threshold pressure. After a fixed time and/or when tank 30 and/or 130 reach a threshold pressure, valve 140 is closed. Once valve 140 is closed valve 145 is opened and the system can be used to supply compressed air. Optionally, the cycle restarts (e.g., by closing valve 145 and/or opening emptying valve 160 beginning the filling cycle e.g., as above.

Typical time duration between subsequent cycles is in the range 5-20 minutes, for example. Typical duration of the first period 205 is in the range 1-5 minutes, for example. Typical duration of the second period 210 is in the range 0.5-3 minutes, for example. Typical duration of the (third) emptying period 210 are in the range 20-120 seconds, for example.

The primary tank 130 may be specified for higher volume than the volume that the secondary tank 135 is specified for, by a factor in the range 2-5, for example. Also, the primary tank 130 may be made to stand higher pressure than the pressure that the secondary tank is made for, by a factor in the range 1.3-2.5, for example.

In case that the compressed air source is a central tank 30, its volume and maximal pressure may higher than those of primary tank 130 by factors in the range of 2-5 and 1.5-3.0, respectively.

In some embodiments, the controller 150 includes a graphical user interface (GUI) 230 for allowing an operator to program the controller duty cycle operation in advance to an automatic operation during a Sabbath.

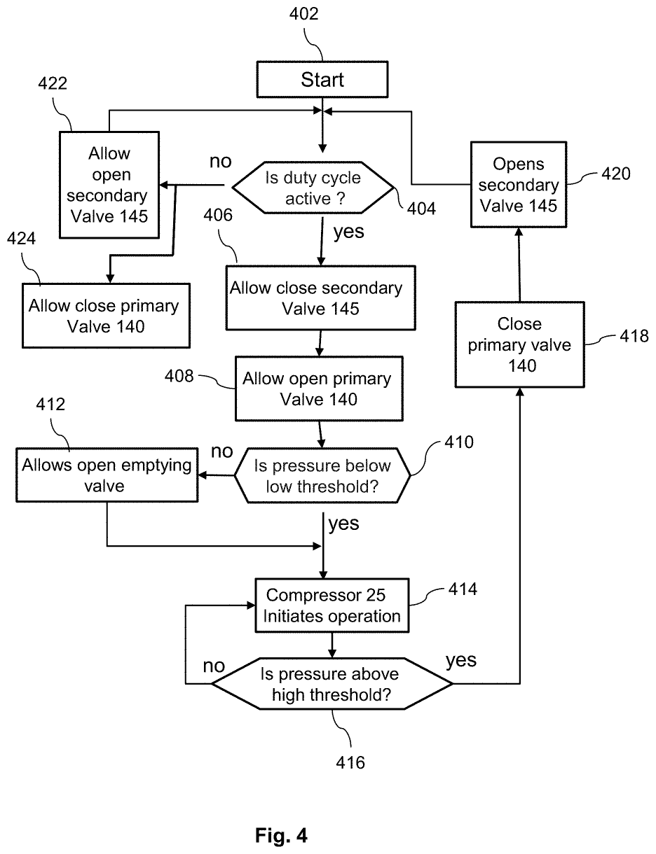

An exemplary flowchart describing the operation of controller 150 is illustrated in the flowchart of FIG. 4. “Allow open a valve”, for example, means that the controller 150 senses the status of the valve. If the valve is already open, it allows it to remain open. If it is closed, the controller 150 opens it.

For example, the cycle may start 402 by checking 404 a status of the cycle. If the duty cycle is active, the controller 150 optionally allows 406 the secondary valve 145 closed and/or allows 408 the primary valve 140 open. Then, the controller 150 optionally senses 410 the pressure of the primary tank 130, and for example, if it is above the low threshold for activating the compressor 25, it allows 412 the emptying valve 160 open. Once the pressure is below the low threshold, the compressor 25 is optionally automatically activated 414. Optionally while the compressor is running, pressure in the primary tank is checked 416. When the pressure in the primary tank 130 rises above the high threshold compressor operation is optionally stopped. For example, then, the compressor stops operation automatically, e.g., the controller 150 closes 418 the primary valve 140 and/or opens 420 the secondary valve 145 until the end of the cycle.

In some embodiments, when the controller checks 404 the status of the duty cycle, if it is not active, then the controller allows 422 opening of secondary valve 145, and/or allows 424 closing primary valve 140.

### A Method for the Operation of a Gas Insulating Interface Embodiment (FIGS. 2A,2B,3, 5)

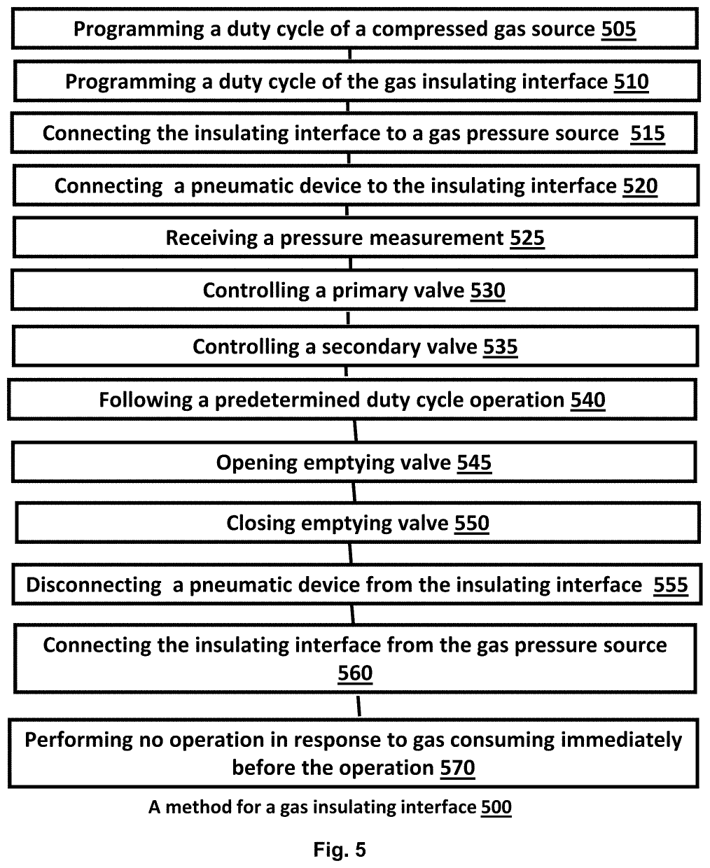

A method 500 for providing a compressed gas using a gas insulating interface 105 is presented in the flowchart of FIG. 5. The gas insulating interface 105 includes a primary gas tank 130 connectable 560 to a compressed gas source (e.g., compressor 25) and a secondary gas tank 135 connectable to sink 15 and/or 20 (e.g., a compressed gas device). The method includes a step 530 of controlling a primary valve 140 switching gas communication between the compressed gas source (e.g., compressor 25) and the primary gas tank 130, and a step 535 of controlling a secondary valve 145 switching gas communication between the primary gas tank 130 and the secondary gas tank 135. The method 500 also includes a step 570 of performing no operation in response to gas consuming immediately before the operation by any of the sink 15, 20 (e.g., compressed gas device).

In some embodiments, the method 500 further includes a step 540 of following a predetermined duty cycle operation.

In some embodiments, the method 500 further includes a step 525 of receiving a gas pressure measurement of the pressure in the primary gas tank 130.

In some embodiments, the method 500 further includes steps 545 and 550 of switching an emptying valve 160 connected with the primary tank 130, a step 545 of opening it and a step 550 of closing it.

In some embodiments, the method 500 further includes a step 515 of attaching the gas insulating interface 105 to the compressed gas source (e.g., compressor 25) and a step 520 of attaching a sink 15 (e.g., compressed gas device) to the gas insulating interface 105. Optionally, when the device has received enough pressurized gas, it is disconnected 555 from the interface.

In some embodiments, the method 500 further includes a step 505 of programming a duty cycle of the compressor 25 using the compressor interface 220 and the communication channel 225, and a step 510 of programming a duty cycle of the gas insulating interface 105 using a graphical user interface (GUI) 230.

It is noted that steps of the method 500 may be executed in an order different from the order of FIG. 5, repeated or skipped. It is noted that there may not be a user interface and/or a user interface may be supplied by a secondary device (e.g., a personal computing device communicating with the controller 150 over a network and/or a wired connection and/or a wireless connection.

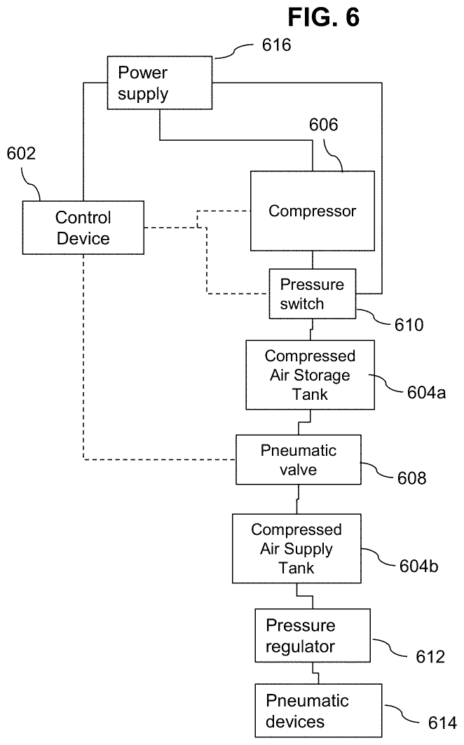

FIG. 6 is a block diagram of an apparatus for producing compressed air, in accordance with an embodiment of the current invention. In some embodiments the apparatus may comprise one or more control devices 602, storage tanks 604a, supply tanks 604b, air compressors 606, pneumatic valves 608, pressure switches 610, pressure regulators 612, air hoses, pneumatic coupling hardware, and/or other pneumatic devices 614 used in the production and/or delivery and or use of compressed air.

In some embodiments of the present invention, the storage tank 604a may include a compressed air storage tank, as is known in the art. In some embodiments of the present invention, the storage tank 604a may receive compressed air from a compressor and/or may deliver compressed air to a supply tank 604b. The storage tank 604a may further be connected to a pressure switch 610.

In some embodiments of the present invention, the supply tank 604a may include a compressed air storage tank, as is known in the art. In some embodiments of the present invention, the supply tank 604a may receive compressed air from another storage tank (e.g., of a previous art compressor system) and/or supply compressed air to external pneumatic devices 614 (e.g., directly without a secondary supply tank 604b). Optionally, the supply tank 604a is connected to a pneumatic valve 608.

In some embodiments of the present invention, the pressure switch 610 comprises an air pressure sensor, a controllable electrical circuit, and/or a means of adjusting a threshold of sensed air pressure. The threshold level of air pressure may be adjusted by an external controller, for example the control device 602, and/or may be adjusted manually, for example by a person adjusting a control knob or lever. The pressure switch 610 may be connected to an air storage tank 604a and/or the pressure sensor may detect a level of air pressure in the storage tank 604a. The controller 602 may include a controllable electrical circuit that may allow electric power to flow from a power supply 616 to an external device, for example a compressor 606, for example when the measured air pressure is below a threshold, and/or prevent electric current and/or voltage from flowing to the external device when the measured pressure is above a threshold.

In some embodiments of the present invention, the compressor 606 may be an electrically driven air compressor. Optionally the compressor 606 may receive electrical power from the pressure switch 610, the control device 602, and/or from any other electrical circuit. Optionally, the pressure switch 610 and/or the control device 602 may control turning on and/or turning off of the electrical power to the compressor 606. Optionally the compressor 606 may be connected directly to an electrical power supply 616, and/or the pressure switch 610 and/or the control device 602 may be connected to the compressor 606 and control the compressor 606 turning itself on and/or off.

In some embodiments of the present invention, the pneumatic valve 608 may be an electrically controlled pneumatic valve 608. Optionally, the pneumatic valve 608 may be connected between the storage tank 604a and the supply tank 604b, and/or control allowing or disallowing flow of compressed air from the storage tank 604a to the supply tank 604b. Optionally the pneumatic valve 608 may be connected to the control device 602, and/or receive control signals from the control device 602 e.g., to open and close the connection between the storage tank 604a and the supply tank 604b.

Optionally, the air hoses may be pneumatic air hoses. Optionally, the air hoses may connect between various devices, for example the compressor 606, the storage tank 604a, the pneumatic valve 608, the supply tank 604b, the pressure regulator 612, and/or any other devices employed in the production and/or supply of compressed air.

In some embodiments of the present invention, the pneumatic devices 614 may comprise one or more devices, for example filters, solenoid control devices, valves, electrical control cables, pilot valves, manual air valves, connector hardware, connector fittings, pressure gauges, transducers, hoses, tubing, air jets, manifolds, and/or any other pneumatic device as is known in the art.

In some embodiments of the present invention, the control device 602 may be a computer, an industrial controller, and/or any other device with capabilities to receive data inputs, for example a signal indicating whether a compressor 606 is operating or not operating, and capabilities to output signals to external devices based on the received inputs, for example a signal indicating to a pneumatic valve 608 to prevent passage of compressed air. For example, the control device may comprise on-off control, open-loop control, feed-forward control, closed-loop control, and/or any other type of control system. Optionally, the control device 602 may comprise a programmable computing device, whereby a user may input parameters of operation, for example the length time of the on duty cycle, the length of time of the off duty cycle, the length of time the pneumatic valve 608 may be open, the threshold value of pressure in the storage tank 604a, and/or any other parameter related to the operation of an embodiment of the present invention. Optionally, the control device 602 comprises a user interface.

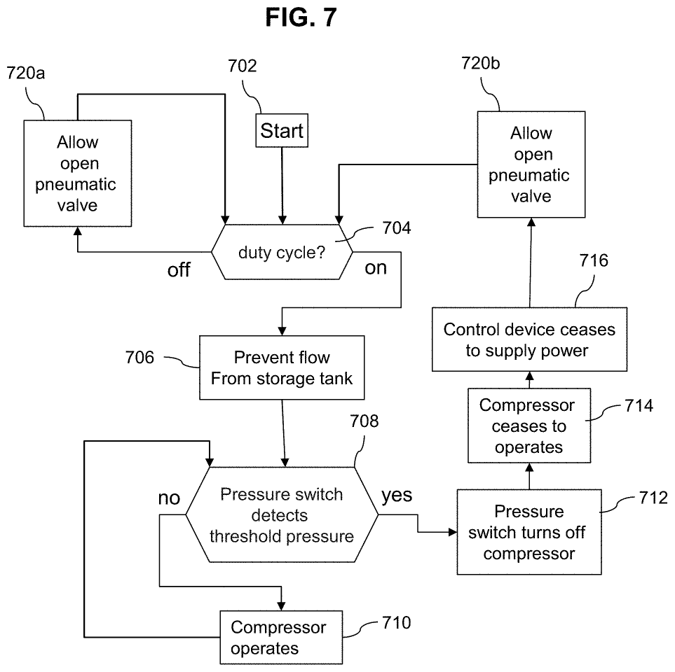

FIG. 7 is a flow chart of a method for producing compressed air, in accordance with an embodiment of the current invention. In some embodiments the method may begin 702 with a control device (e.g., a controller) checking 704 the duty cycle of the pressure source.

Optionally, when entering the on period, the control device sends a signal to the pneumatic valve which closes the valve if it was open, thereby preventing 706 compressed air from flowing from the storage tank to the supply tank. Optionally, during the duration of the on period when the compressor is operating, the control device prevents the pneumatic valve from being opened.

Optionally, during the on period, the control device and or pressure switch detects 708 if the supply tank has reached a desired pressure. If not, the controller options provides electrical power to operate 710 the compressor, either directly or via the pressure switch.

Optionally, the pressure switch continuously measures the air pressure in the storage tank.

Optionally, when the pressure switch detects 708 that the measured air pressure is above a threshold value, the pressure switch causes the compressor to turn off 712 and/or ceases 714 operations of the compressor.

Optionally, the control device causes 716 the supply of electrical power to the compressor to turn off 712 when the control device detects that the compressor is turned off 712 during an on period of the duty cycle.

Optionally, when the duty cycle proceeds to complete the current on period and then completes the following off period, the duty cycle enters the next on period.

Optionally, the control device allows 720a, 720b the pneumatic valve to open for a programmable time period during the off period of the duty cycle, and/or during the on period of the duty cycle when the compressor is not operating. Optionally, the pneumatic valve may be opened manually by a user at any time. In some embodiments, closing the pneumatic valve by the control device overrides the manual opening.

Optionally, when the pressure switch detects 708 that the measured air pressure is below a threshold value, the pressure switch allows the compressor to receive power and operate 710.

In some embodiments, before operating 710 the compressor and/or connecting the storage tank to the air source, pressure will be released from the storage tank.

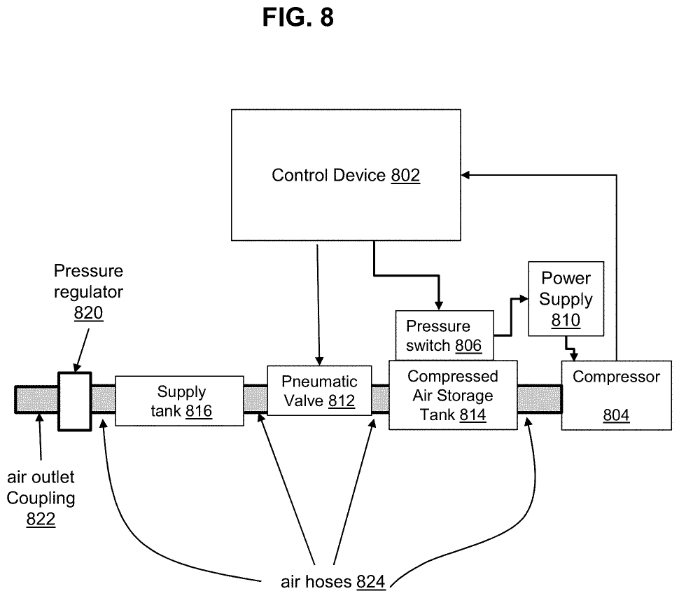

FIG. 8 is a schematic drawing of an apparatus for producing compressed air, in accordance with an embodiment of the current invention. In an aspect of some embodiments of the present invention, the controlling device 802 controls a power supply 810 that delivers power to the compressor 804 with a periodic duty cycle of alternating periods of supplying power and not supplying power.

Optionally, the control device comprises an on/off switch. Optionally, when the control device is switched on, the control device enters the beginning of the on period of the duty cycle. Optionally, when the control device is switched off, the entire apparatus is turned off.

Optionally, the duty cycle on period and off period may be substantially equal, the on period may be longer than the off cycle, and/or the off period may be longer than the on period. Optionally, the on and/or the off time period may be any period of time from 0.1 to 5 seconds, 5 to 30 seconds, 30 to 120 seconds, 120 to 1200 seconds, 1200 to 10,000 seconds, and/or any other period of time.

In an aspect of some embodiments of the present invention, the pressure switch 806 may turn off the compressor 804 when the threshold pressure value has been reached. To turn off the compressor, the pressure switch may prevent electrical power from reaching the compressor, and/or a control connection to the compressor 804 may cause the compressor 804 to turn itself off.

In an aspect of some embodiments of the present invention, the pressure switch 806 may signal to the control device 802 that the threshold pressure value has been reached, and the control device 802 may then turn off the compressor 804. To turn off the compressor 804, the control device 802 may prevent electrical power from reaching the compressor 804, and/or the control device 802 may have a control connection to the compressor 804 and cause the compressor 804 to turn itself off. Optionally, the control device 802 may supply power for functioning of the pressure switch 806 independent of supplying power for the compressor 804 via the pressure switch 806.

In an aspect of some embodiments of the present invention, the control device 802 may receive from the compressor 804 a data signal indicating whether the compressor 804 is operating or not operating. Optionally, when the control device 802 receives a data signal indicating that the compressor 804 is not operating during an on period of the duty cycle, the control device 802 may cause the supply of electric power to the compressor 804 to turn off, for example by stopping the supply of power to the compressor 804, by stopping a power supply 810 to the pressure switch 806, and/or by a control signal to the pressure switch 806 to turn off the supply of electric power.

Optionally, when the control device 802 receives a data signal indicating that the compressor 804 is operating, the control device 802 sends a data signal to the pneumatic valve 812 causing the valve 812 to close.

In an aspect of some embodiments of the present invention, the control device 802 controls the opening and closing of the pneumatic valve 812. For example, the control device 802 may open the pneumatic valve 812 for a defined time period, and only when the compressor 804 is not operating. The defined period of time may be between 5 to 30 seconds, from 30 seconds to 2 minutes, from 2 to 10 minutes, and/or any other period of time that concludes prior to the beginning of the next operation of the compressor 804. Optionally, the pneumatic valve 812 is closed by the control device 802 prior to allowing the compressor 804 to begin operating. Additionally or alternatively, the control device 802 may empty the supply storage tank 814 before activating the compressor 804 and/or before an on cycle of the compressor 804. For example, the pneumatic valve 812 may have an outlet to a pressure release (e.g., the external atmosphere) for empty in pressure. Alternatively or additionally, there may be a separate pressure release/emptying valve.

In an aspect of some embodiments of the present invention, the pneumatic valve 812 may be opened and/or closed manually, for example by turning a knob, activating an electrical control, and/or any other method of activating a pneumatic valve 812. Alternatively and/or additionally, the manual opening and/or closing of the pneumatic valve 812 may be overridden by the control device 802. For example, when the control device 802 shuts the pneumatic valve 812, the manual operation of opening the valve 812 will be prevented from taking effect.

In some embodiments of the current invention a pneumatic device (i.e., a wheel chair and/or an elderly cart and/or a utility cart and/or a lift and/or hospital bed) may be run on compressed air and controlled by a Shabbat observant Jew on Shabbat without desecrating the Shabbat. Optionally the device may run on compressed air supplied by a pressure tank 816 power supply that is refilled from a fixed compression system. Alternatively or additionally, the pneumatic device will include an on board compressor and/or power source (e.g., a battery). The pressure may be high or low. In some embodiments, higher pressure will be used by a vehicle that does not have its own compressor, allowing the vehicle to store more energy in the form of high pressure compressed air.

In an aspect of some embodiments of the present invention, the pressure switch 806 detects a threshold air pressure in the storage tank 814. The threshold pressure may be between 50 to 100 psi, between 100 to 150 psi, between 150 to 300 psi, between 300 and 2000 psi, between 2000 and 3000 psi, between 3000 and 4500 psi, between 4500 and 6000 psi, and/or any other range of air pressure. Optionally, the pressure in the storage tank may be in a ratio of 1.5:1, 2:1, 3:1, and or any other ratio compared to the requirements of a pneumatic device to be powered by the present invention. In a preferred embodiment, the pressure in the storage tank 814 may be in a ratio of 2:1 compared to the required pressure of a pneumatic device to be powered by the present invention.

Optionally, the pressure in the storage tank 814 may be in a ratio of 1.5:1, 2:1, 3:1, and or any other ration compared to the pressure in the supply tank 816. In a preferred embodiment, the pressure in the storage tank 814 may be in a ratio of 2:1 compared to the pressure in the supply tank 816.

Optionally, the pressure regulator 820 may be adjusted to supply a substantially constant pressure. For example, when a pressure of 100 psi is desired, the pressure regulator 820 may be adjusted to supply 100 psi from the supply tank 816. Optionally, the pressure regulator 820 may be adjusted manually and/or controlled by the control device 802.

In an aspect of some embodiments of the present invention, the supply tank 816 is detachable from the pneumatic valve 812 and/or there may be a separate mobile supply tank 816 and/or a fixed supply tank (for example as illustrated in FIG. 4). Optionally, the detachable supply tank 816 may be attached to mobile and/or remote pneumatic devices, thereby providing pneumatic pressure remotely from the other components of the present invention. Optionally, the supply tank 816 may be removably attached to the outlet valve 822 to be refilled with compressed air. In a preferred embodiment, when the supply tank 816 may be detachably deployed remotely from the other components of the present invention, the air pressure of the storage tank may be 3000 to 4500 psi. Components of the invention are optionally attached together using air hoses 824

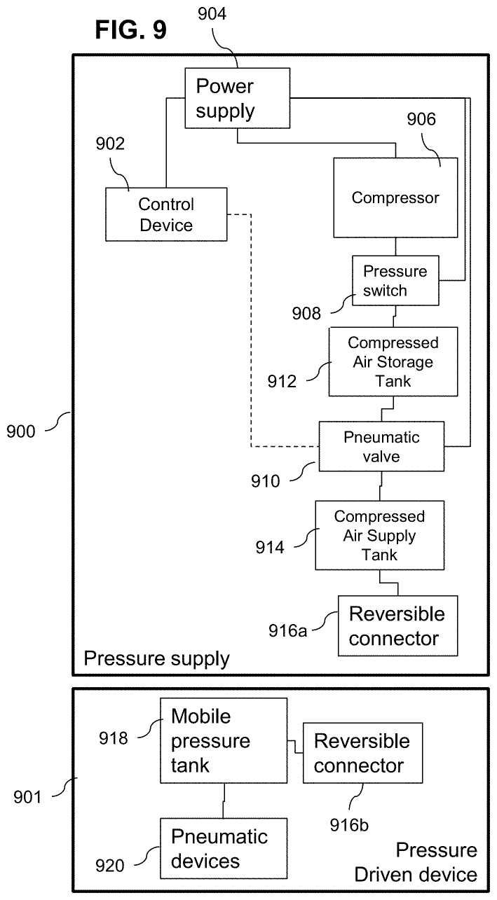

FIG. 9 is a block diagram of a pressure supply 900 and a pressure driven device 901 in accordance with an embodiment of the current invention. In some embodiments, a pressure supply 900 may be designed to supply pressure to a pressure driven device 901 in accordance with Jewish Halacha on Shabbat and/or Holidays.

In some embodiments, a control device 902 controls and/or receives data from a power supply 904, and/or a pneumatic valve. In some embodiment, the control device may control a compressor 906 and/or a pressure switch. Alternatively or additionally, the compressor 906 and/or pressure switch 908 may function independently of the control device 902. For example, a compressed air source including the compressor 906 and/or pressure switch 610 and/or a compressed air tank 912 may be powered according to a fixed duty cycle. During the on portion of the cycle, the pressure switch 908 may sense a pressure in the storage tank 912. When the pressure is below a threshold the compressor 906 may be activated to supply pressurized air to the storage tank 912. When the pressure is above the threshold the compressor 906 may be de-activated. During the off portion of the duty cycle, the compressor 906 is optionally de-activated unconditionally. Optionally, the compressor 906 and/or pneumatic valve 910 is controlled without regard to the state of pressure in the compressed air supply tank 914 and/or supply of pressure to the pressure driven device 901.

In some embodiments, during the on portion of the duty cycle, the control device closes pneumatic valve 910 between the compressed air storage tank 912 and one or both of the supply tank 914 and/or a pressure driven device 901. Optionally, during all or part of the off portion of the duty cycle, the control device opens pneumatic valve 910 between the compressed air storage tank 912 and one or both of the supply tank 914 and/or a pressure driven device 901.

In some embodiments, before the pneumatic valve 910 is opened, pressure is released from the compressed air supply tank 914 and/or the compressed air storage tank 912 (for example the pneumatic valve 910 may have a pressure release channel which is opened to release pressure before the start of a duty cycle of the compressor 906.

In some embodiments, reversible connectors 916a, 916b allowing reversible connection between the pressure driven device 901 and the pressure supply 900. Alternatively or additionally, the pressure driven device 901 may be fixedly connected to the pressure supply 900.

In some embodiments, a pressure driven device 901 may receive compressed air directly from the pneumatic valve 910 (e.g., in such an embodiment there may not be a supply tank 914 separate from the storage tank 912. For example, during the on portion of the duty cycle, the pressure driven device 901 will not be able to receive air.

In some embodiments, a pressure driven device 901 may receive compressed from supply tank 914. For example, during the on portion of the duty cycle, the pressure driven device 901 will be able to receive air from the supply tank 914 while it is isolated by the pneumatic valve 910 form the storage tank 912 and/or compressor 906.

In some embodiments, a pressure drive device 901 may include a mobile pressure tank 918 and/or pneumatic devices 920.

It is expected that during the life of a patent maturing from this application many relevant pressure sources and/or pneumatic devices will be developed and the scope of the terms is intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is also included (for example the ranges from 1 to 2 and/or from 2 to 4 also includes the combined range from 1 to 4).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A gas insulating interface for interfacing a compressed gas source with one or more compressed gas devices, the gas insulating interface comprising:
a primary gas tank for receiving a compressed gas from said compressed gas source;
a secondary gas tank for receiving a compressed gas from said primary gas tank and for providing a compressed gas to said one or more compressed gas devices;
a primary valve for controlling gas communication between said compressed gas source and said primary gas tank;
a secondary valve for controlling gas communication between said primary gas tank and said secondary gas tank; and
a controller configured to control of said primary valve and said secondary valve by a plurality of automatic control operations, no control operation thereof responding to gas consuming immediately before said control operation by said one or more compressed gas devices.

2. The gas insulating interface of claim 1, further comprising a pressure gauge for measuring gas pressure in said primary gas tank and communicating gas measurements to said controller.

3. The gas insulating interface of claim 1, wherein said controller is configured to follow a predetermined duty cycle operation.

4. The gas insulating interface of claim 3, wherein each cycle of said predetermined duty cycle operation includes a first period of closed secondary valve and open primary valve, and a second period of closed primary valve and open secondary valve.

5. The gas insulating interface of claim 4, further comprising an emptying valve to enable controlled flow of gas out of said primary gas tank, and wherein an opening of said emptying valve is synchronized with said duty cycle.

6. The gas insulating interface of claim 1 wherein the compressed gas source is one of a certain compressor and a central compressed gas tank, said central compressed gas tank configured for initiating an attached central compressor upon reduction of gas pressure below a certain threshold.

7. The gas insulating interface of claim 6, wherein said certain compressor is programmed to start compressing in a predetermined duty cycle.

8. The gas insulating interface of claim 1, wherein at least one of said one or more compressed gas devices is chosen from a group of devices consisting of a lifting device, a raising and lowering mechanism of a bed, a pneumatic wheelchair, a mobility scooter, an elevator, a solenoid control device, a manual air valve, and an air jet.

9. The gas insulating interface of claim 1, wherein said controller is chosen from a group of devices consisting of a computer, an industrial controller, and a programmable computing device.

10. The gas insulating interface of claim 1 wherein said controller includes a user interface for allowing programming of a duty cycle operation of said gas insulating interface.

11. The gas insulating interface of claim 1 further comprising at least one of a detachable connector to the compressed gas source and a detachable connector to at least one of said one or more compressed gas devices.

12. The gas insulating interface of claim 1, further comprising a communication channel to the compressed gas source for at least one of receiving a status thereof and preprogramming a duty cycle of an operation of said compressed gas source.

13. An interface between a compressor activated according to a duty cycle and pressure sink comprising:
a controller synchronized to said duty cycle; and
a pneumatic valve positioned on a flow path between said compressor and said pressure sink, said pneumatic valve synchronized by said controller to said duty cycle of said compressor.

14. The interface of claim 13, wherein said controller is configured to close said pneumatic valve during an actor portion of said duty cycle.

15. The interface claim 13, further comprising a pressure storage tank positioned on a flow path between said compressor and said pneumatic valve and a pressure sensor responsive to a pressure in said pressure storage tank and wherein said compressor is responsive to said pressure sensor to stop compressing when a pressure in said pressure storage tank is greater than a threshold.

16. The interface of claim 15, further comprising a pressure release configured to release pressure from said pressure storage tank prior to opening said pneumatic valve.

17. A method of supplying pressure from a compressor to a pressure sink comprising:
activate said compressor according to a duty cycle having an active period and an inactive period;
block a flow path between the compressor and the pressure sink during said active period; and
allow flow along said flow path during said inactive period only.

18. The method of claim 17, further comprising:
collect pressurized gas in a storage tank during said active period and wherein said flow path is between said storage tank and said pressure sink.

19. The method of claim 18, further comprising shut of said compressor during said active period when a pressure in said storage tank is greater than a threshold.

20. The method of claim 19, further comprising releasing pressure from said storage tank before a beginning of said active period.
